(19) United States
(12) Patent Application Publication
(10) Pub. No.: US 2019/0269277 A1
(43) Pub. Date: Sep. 5, 2019

(54) GRINDER

(71) Applicant: 10660469 Canada Inc., Aurora (CA)

(72) Inventor: Justin Ronald Brady Larose, Aurora (CA)

(73) Assignee: 10660469 Canada Inc., Aurora (CA)

(21) Appl. No.: 15/910,634

(22) Filed: Mar. 2, 2018

(51) Int. Cl. A47J 42/34

(52) U.S. Cl. CPC A47J 42/34

(57) ABSTRACT

A cannabis grinder includes a pair of square-cuboid-shaped body portions and a pair of grinding assemblies. One of the body portions has one of the grinding assemblies recessed in a substantially square face thereof. The other grinding assembly extends from a substantially square face of the other body portion. The grinding assemblies have teeth that are arranged to allow relative rotation of the grinding assemblies without interference between the teeth. Corners of a body portions proximate the grinding assembly are shaped to avoid striking digits of a user gripping the body portions during the relative rotation. Various methods of manufacturing and using such a grinder are also described.

### FIELD

This relates to grinders and, in particular, to grinders for cannabis.

### BACKGROUND

Cannabis can require breaking up into fragments in order to consume it in particular ways. More particularly, particular sized fragments may be preferable for particular manners of consumption.

For example, cannabis may be ground finely for vaporization, ground less finely for use in a marijuana cigarette or joint, or ground even less finely for consumption in a marijuana pipe or bowl.

Commonly available grinders such as those for cannabis or marijuana are generally elliptical or spherical with two halves that separate to expose a grinding chamber. The two halves have teeth or pegs aligned so that, when the halves are turned, material placed inside the chamber in ground or shredded.

### BRIEF DESCRIPTION OF THE DRAWINGS

Embodiments are described in detail below with reference to the following drawings:

FIG. 1 is a perspective view of a grinder, exemplary of an embodiment;

FIGS. 2A and 2B are perspective views of the grinder of FIG. 1 showing top and bottom portions thereof, respectively;

FIG. 3 is a perspective view of the grinder of FIG. 1, illustrating operation thereof;

FIGS. 4A and 4B are plan views of the grinder of FIG. 1 showing top and bottom portions thereof, respectively;

FIG. 5 is an exploded perspective view of the grinder of FIG. 1;

FIG. 6 is an elevation view of the grinder of FIG. 1;

FIG. 7A is an elevation view of a section of the grinder of FIG. 6, along a line 7-7 in the direction of the arrows;

FIG. 7B is a perspective view of the same section of the grinder of FIG. 6 shown in FIG. 7A;

FIG. 8 is an elevation view of a section of the grinder of FIG. 7, along a line 8-8 in the direction of the arrows;

FIG. 9 is an elevation view of an outer face of the grinder of FIG. 1 grinder according to an alternate embodiment;

FIGS. 10A and 10B are exploded, perspective views of grinders showing top and bottom portions thereof, respectively, according to further alternate embodiments;

FIG. 11 is a flow diagram illustrating a first process for manufacturing a grinder in accordance with FIG. 1;

FIG. 12 is a flow diagram illustrating a second process for manufacturing a grinder in accordance with FIG. 1;

FIG. 13 shows a portion of another embodiment of a grinder;

FIG. 14 shows a portion of another embodiment of a grinder; and

FIG. 15 shows another portion of another embodiment of a grinder.

Like reference numerals are used in the drawings to denote like elements and features.

### DETAILED DESCRIPTION OF VARIOUS EMBODIMENTS

Conventional ellipsoid or spherical grinders can be difficult for some individuals to operate. For example, persons with conditions such as, for example, arthritis may have trouble exerting sufficient force to grip a rounded shape. In another example, persons with conditions such as, for example, multiple sclerosis may have motor control issues that make grasping a rounded shape difficult. This may hinder the ability of such users to employ such a grinder. For example, it may be a particular problem for persons with arthritis or multiple sclerosis to employ such a grinder in preparing medical marijuana for consumption.

A grinder having a generally square or rectangular rather than a round or elliptical cross section may be easier to grip or grasp such as, for example, due to the various substantially straight edges inherent in a grinder having a generally square or rectangular cross-section shape. Such a grinder may provide additionally leverage as compared to those having a round or elliptical cross section and may, therefore, allow difficult materials to be more easily ground. However, there may be various considerations in providing a grinder having a generally square or rectangular cross section.

In order to operate a grinder a user may grasp each half of the assembled grinder in one of their hands. Notably, while so grasping, one or more of a user's fingers may extend beyond edges of a respective portion of the grinder to be proximate the other portion of the grinder. For example, a finger tip or a finger nail, especially if the user has long or acrylic nails, may so extend. If a grinder is cylindrical or spherical, this may be of little to no consequence, with any contact with the other side of the grinder by a particular digit being largely incidental. For example, it may be that such contact merely provides “drag” which slightly opposes relative rotation of the halves of the grinder. A generally cuboid-shaped grinder, however, will have corners. Such corners may strike the tips of a user's fingers. Such striking may present problems. For example, if a user has long or acrylic fingernails, it may be the corners could damage the nails such as, for example, by causing cracks, chips, or otherwise hurting the fingernail or spoiling a manicure thereof. In another example, users, such as, for example, those with various medical conditions, may experience particular pain or discomfort upon such a strike of a digit. Accordingly, it may be desirable to mitigate the probability or the impact of such finger strikes.

The probability and/or impact of such strikes may be reduced, by appropriately shaping corners of each half of the grinders that are proximate the grinding assembly—i.e., corners that will fall close to the seam between the halves of the grinder when it is assembled for grinding. For example, the corners may be reduced and/or shaped by rounding, beveling or chamfering them to a sufficient degree as to avoid them striking digits of the user gripping the part of the grinder during relative rotation of the halves of the grinder.

Such a substantially-cuboid grinder may be formed using various techniques as further described below. For example, such a grinder may be formed using milling techniques such as, for example, by way of Computer Numerical Control (CNC) milling of a suitable material such as, for example, aluminum.

In some applications or market segments a grinder formed entirely of a material suitable for CNC milling may be undesirable. For example, it may be desirable to use other materials for aesthetic and/or functional reasons. In another example, it may be cost-prohibitive to form a grinder entirely of a material suitable for forming grinding assemblies such as, for example, aluminum. Accordingly, it may be desirable to use manufacturing techniques to allow multiple materials to be combined in manufacturing a grinder.

One or more of the above considerations may be addressed by subject matter of the present application.

In one aspect, there is provided a grinder comprising: a first substantially square-cuboid-shaped body portion having a first cylindrical grinding assembly recessed in a substantially square face thereof, the first cylindrical grinding assembly including a first plurality of teeth; a second substantially square-cuboid-shaped body portion; a second cylindrical grinding assembly extending from a substantially square face of the second substantially square-cuboid-shaped body portion and adapted to be rotateably received in the first grinding assembly to define a grinding chamber, the second grinding assembly including a second plurality of teeth positioned to allow relative rotation between the first and second grinding assemblies without interference between teeth of the first and second plurality of teeth, wherein corners of one of the first and second body portions proximate a respective one of the first and second grinding assemblies are shaped to avoid striking digits of a user gripping the other of the first and second body portions during the relative rotation.

In another aspect, there is provided a method of manufacturing a grinder comprising: forming a first cylindrical grinding assembly, the first cylindrical grinding assembly including a first plurality of teeth; forming a second cylindrical grinding assembly, the second grinding assembly being adapted to be received in the first grinding assembly to define a grinding chamber and including a second plurality of teeth positioned to allow relative rotation between the first and second grinding assemblies without interference between teeth of the first and second plurality of teeth; forming a first substantially square-cuboid-shaped body portion having a recessed portion in a substantially square face thereof for receiving the first grinding assembly; assembling the first grinding assembly in the recessed portion of the first body portion; forming a second substantially square-cuboid-shaped body portion having a recessed portion in a substantially square face thereof for partially receiving the first grinding assembly; and assembling the second grinding assembly in the recessed portion of the second body portion so that the second grinding assembly extends from the substantially square face of the second body portion, wherein corners of at least one of the first and second body portions proximate the respective substantially square face thereof and proximate a respective one of the first and second grinding assemblies are shaped to avoid striking digits of a user gripping the other of the first and second body portions during the relative rotation.

In another aspect, there is provided a method of manufacturing a grinder comprising: forming a first cylindrical grinding assembly, the first cylindrical grinding assembly including a first plurality of teeth; using injection molding to over mould a first substantially square-cuboid-shaped body portion over the first grinding assembly so that the first grinding assembly is recessed in a substantially square face of the first body portion; forming a second cylindrical grinding assembly, the second grinding assembly being adapted to be received in the first grinding assembly to define a grinding chamber and including a second plurality of teeth positioned to allow relative rotation between the first and second grinding assemblies without interference between teeth of the first and second plurality of teeth; using injection molding to over mould a second substantially square-cuboid-shaped body portion over the second grinding assembly so that the second grinding assembly is partially recessed in a substantially square face of the second body portion; and wherein the injection molding of at least one of the first and second body portions is adapted to form corners of the at least one of the first and second body portions proximate the respective substantially square face thereof and proximate a respective one of the first and second grinding assemblies with a shape configured to avoid striking digits of a user gripping the other of the first and second body portions during the relative rotation.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Any feature described in relation to one aspect or embodiment of the invention may also be used in respect of one or more other aspects/embodiments. These and other aspects of the present invention will be apparent from and elucidated with reference to, the embodiment described herein. An embodiment of the present invention will now be described, by way of example only, and with reference to the accompanying drawings.

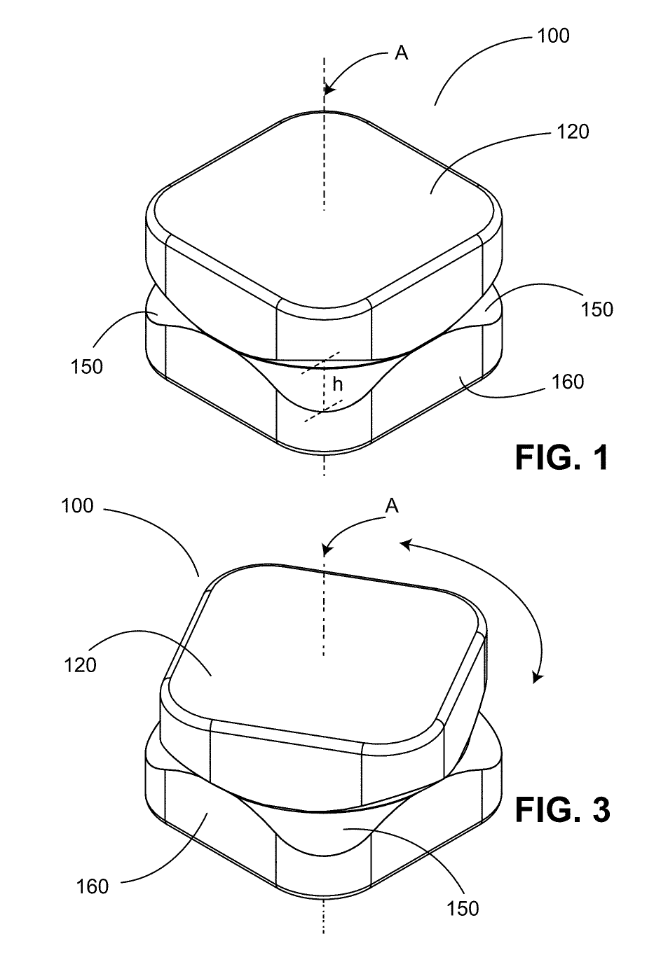

FIG. 1 is a perspective view of a grinder 100, exemplary of an embodiment.

As illustrated, the grinder 100 includes a top body portion 120 and a bottom body portion 160.

The top body portion 120 are the bottom body portion 160 are each substantially square-cuboid shaped. Conveniently, body portions so shaped may be easy to grip or grasp as compared to body portions having a circular or elliptical cross section. Additionally or alternatively, edges of a grinder so shaped may provide vantage points for gripping such as may, for example, allow gripping by persons with reduced dexterity. Additionally or alternatively, a substantially square cross section may such as, for example, due to reasons of leverage, allow a greater force to be more easily imparted on material being ground as compared to cylindrical or ellipsoid grinders. This may, for example, allow material to be ground that would jam or stick in a cylindrical or ellipsoid grinder. Additionally or alternatively, it may be that material may be ground by a person identifying with certain disabilities using a grinder having a substantially square cross section more easily than with a cylindrical or ellipsoid grinder.

One or both of the top body portion 120 and the bottom body portion 160 may, as shown, have rounded vertical edges. For example, the top body portion 120 and the bottom body portion 160 may each have a rounded square cross-section or a squircle cross-section.

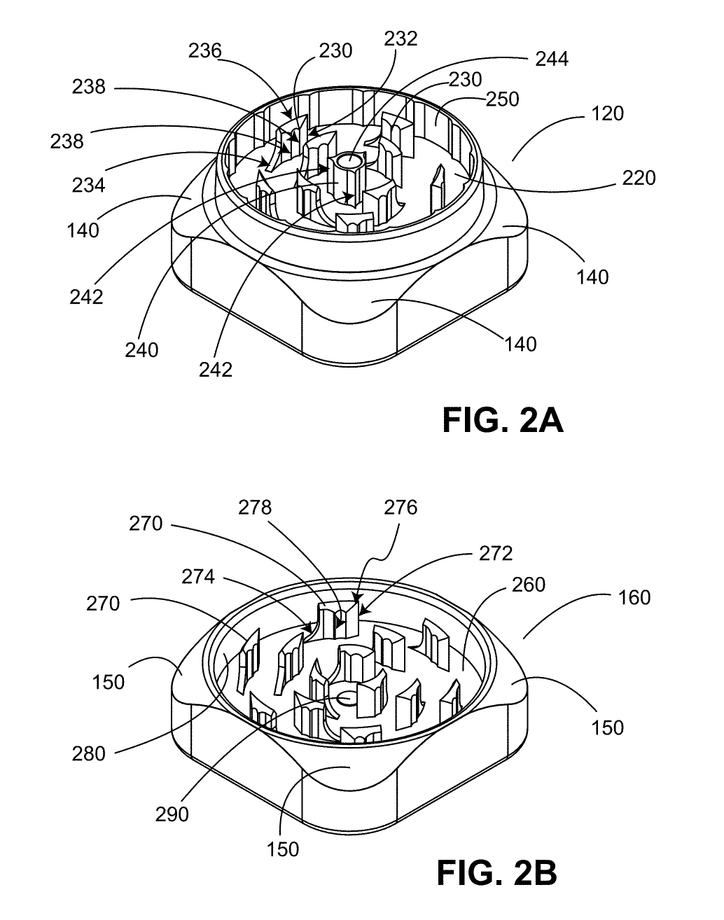

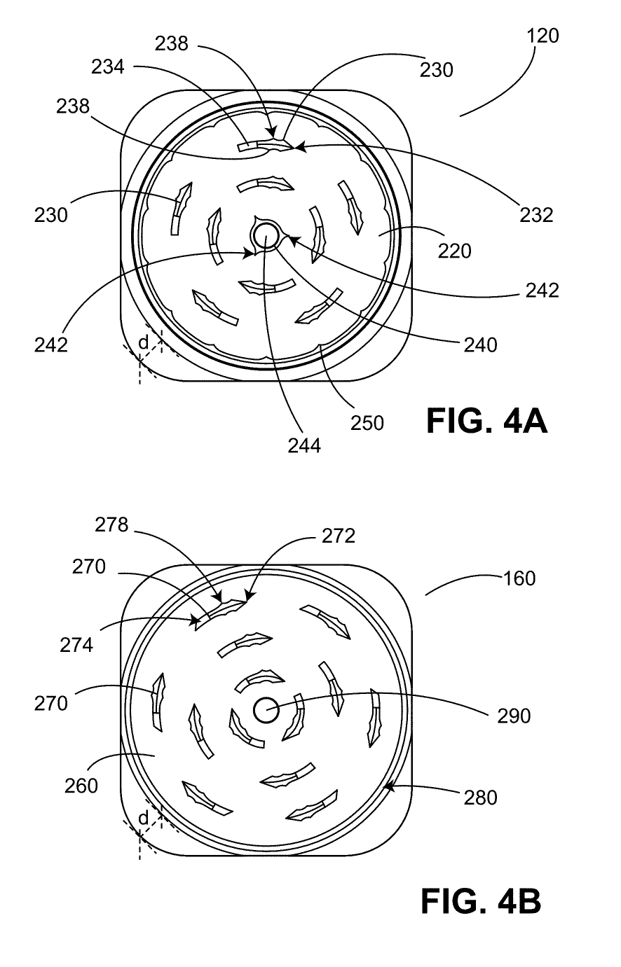

The top body portion 120 and the bottom body portion 160 are also shown, separately, in perspective in FIGS. 2A and 2B, respectively. Additionally, plan views of the top body portion 120 and the bottom body portion are also provided in FIGS. 4A and 4B, respectively.

Referring to FIG. 3, the top body portion 120 and the bottom body portion 160 may be rotated relative one another to grind material contained in a grinding chamber (not shown) of the grinder 100 as is formed between the top body portion 120 and the bottom body portion 160 when they are placed together. For example, it may be the relative rotation is about an axis of the relative rotation A.

The top body portion 120 and the bottom body portion 160 may, as further described below, be separated and/or placed together. In particular, the top body portion 120 and the bottom body portion 160 may be separated to allow material to be placed in the grinding chamber of the grinder 100 and then the material can be ground by joining the top body portion 120 and the bottom body portion 160.

As best shown in FIG. 2A, a top grinding assembly 220 protrudes or extends from the top body portion 120. Corners 140 of the top body portion 120 may be shaped to avoid striking digits of a user gripping the bottom body portion. For example, the corners may be rounded as shown. Alternatively, one or more of the corners may be shaped by rounding, bevelling, or chamfering. Conveniently, a rounded corner may be produced using a lathe. By contrast, a straight bevel may require alternative manufacturing techniques. For example, it may be necessary to employ a five axis CNC mill.

As illustrated, the top grinding assembly 220 is substantially cylindrical in shape. The top grinding assembly 220 includes a plurality of teeth 230. Additionally, the top grinding assembly 220 may also, as shown, include an axle 240.

The teeth 230 may be arranged in one or more circles. For example, as shown, at least three of the teeth 230 may define each of the one or more circles. The circles may be concentric with the outer edge of the top grinding assembly 220. Put differently, the circles may be concentric with the centre of the axle 240. Put yet another way, the circles may be coaxial with the axis A (FIG. 3) of relative rotation between the top body portion 120 and the bottom body portion 160 when assembled. As such, at least three teeth may be arranged circumferentially along the one or more circles.

The teeth 230 may be variously shaped. For example, the teeth 230 may, as illustrated be arc-shaped such as, for example, when they are arranged to define one or more circles as described above. Additionally or alternatively, each tooth 230 may have one or more cutting edges. For example, a tooth 230 may, as illustrated, have a substantially straight cutting edge 232. In another example, a tooth 230 may, as illustrated, have a cutting edge with a filleted base 234.

Notably, one or the other of the straight cutting edge 232 and the filleted base 234 may attack material received in the grinder 100 when the relative rotation is one direction or the opposite direction, respectively.

It may be that, as illustrated, each tooth 230 has a straight cutting edge 232 and a cutting edge having a filleted base 234. The cutting edge having a filleted base 234 may be substantially blunt as compared to the straight cutting edge 232.

The filleted base 234 may act as scoop, adding a component to forces exerted on material during grinding perpendicular to the axis of relative rotation A. Conveniently, in this way, material may be caused to agitate throughout the grinding chamber during grinding. Additionally or alternatively, resistance to grinding may be more easily overcome with material being driven a greater distance within the grinding chamber during relative rotation.

It may be that, as illustrated, the different types of cutting edge are uniformly oriented on each tooth 230. Additionally, as further described below and shown in FIG. 2B, similarly oriented teeth with correspondingly oriented cutting edges may be associated with the bottom body portion 160. Conveniently, in this way, relative rotation in each direction may have an associated type of cutting edge attacking material on the bottom edge. This may allow particular grinds to be selectively provided. For example, it may be that attacking cannabis with only straight cutting edges may cause cannabis to be ground more finely while attacking cannabis with only cutting edges having a filleted base may provide a looser grind. More finely ground cannabis may be suited for a consumption using a vaporizer while loosely ground cannabis may be suited for a combustion in a marijuana pipe. In another example, it may be that by rotating the top body portion 120 and the bottom body portion 160 in a back-and-forth fashion (see, e.g., FIG. 3), material may be attacked by both varieties of cutting edge. Conveniently, in this way, an in-between grind may be provided. An in-between grind of marijuana, for example, may be suited for use in rolling a marijuana cigarette or joint. In another example, mixed material may be ground. For example, tobacco and cannabis may be ground at the same time. In a particular example, tobacco and cannabis may be ground together to produce a mixed in-between grind such as may, for example, be rolled together in a mixed cigarette or spliff. When multiple materials are ground together, the relative rotation of the body portions may also serve to mix the different types of ground material together. Conveniently this may allow a user to more easily prepare a mixed cannabis/tobacco cigarette (a “spliff”), for example.

In another example (not shown), it may be that similarly oriented teeth with oppositely oriented cutting edges may be provided in association with the bottom body portion 160. Conveniently, in this way, a grinder offering an in-between grind without requiring back-and-forth operation may be provided. This may, for example, allow users with mobility or cognitive difficulties to easily prepare material with an in-between grind for use in, for example, a joint.

Returning to FIG. 2A, it may also be that a cutting edge 236 is provided substantially perpendicular to the axis of the relative rotation A. Conveniently, such a cutting edge may facilitate closure of the grinder 100 whereby the cutting edge 236 may slice through material to be ground, thereby allowing the top body portion 120 to be pushed towards and mated with the bottom body portion 160.

Additionally or alternatively, one or more vanes 238 may be provided extending along one or both of the faces of the tooth 230 that are approximately tangential to the relative rotation/the circle to which a particular tooth 230 belongs. The vanes 238 may act to apply a shear force to material during grinding as the top body portion 120 is rotated relative to the bottom body portion 160.

An axle 240 may be included in the top grinding assembly 220. The axle 240 is substantially parallel to the axis of relative rotation A and, more particularly, may be aligned therewith. Vanes 242 may extend along the axle in a direction substantially parallel to the axis of relative rotation A. Conveniently, the vanes 242 may act to sweep material outwards towards the teeth 230 during relative rotation of the grinder 100. Vanes 242 may also provide some cutting action. Additionally or alternatively, the vanes 242 may limit spindling of material around the axle 240 during grinding. For example, cutting and/or sweeping action of the vanes 242 may act to limit spindling.

The axle 240 may include a magnet 244. The magnet 244 may cooperate with a magnet of the bottom body portion 160 (described further below) and/or ferromagnetic material of the body portion 160 for selectively maintaining the grinder 100 in an assembled state. Conveniently, this may allow the grinder 100 to be transported in an assembled state such as, for example, in a bag or backpack. Notably, if the grinder 100 is maintained in an assembled state is may be used for storage of material to be ground and/or ground material.

The magnet 244 may be a rare earth magnet such as, for example, a neodymium magnet. In a particular example, the magnet 244 may be an N52 magnet.

The magnet 244 may be secured in the axle 240 via a friction fit. Additionally or alternatively, a suitable adhesive may be employed such as, for example, an epoxy resin.

An inner edge 250 of the top grinding assembly 220 may be scalloped or corrugated. Scallops may act to prevent material collecting around the inner edge 250 of the grinding assembly during grinding. Additionally or alternatively, the scallops around the inner edge 250 may act to sweep material inwards towards during the teeth 230 during the relative rotation of the grinder 100 during grinding.

Referring to FIG. 2B, a bottom grinding assembly 260 may be recessed in a substantially square face of the bottom body portion 160. As further described below, the top grinding assembly 220 may be received in the bottom grinding assembly 260 to assemble the grinder 100. Further, the top grinding assembly 220 may be rotated relative to the bottom grinding assembly 260 by rotating the top body portion 120 relative to the bottom body portion 160. As such, the top grinding assembly 220 is rotateably received in the bottom grinding assembly 260.

As illustrated, corners 150 of the bottom body portion 160 may be shaped to avoid striking digits of a user gripping the bottom body portion, akin to the corners 140. For example, the corners may be rounded as shown. Alternatively, one or more of the corners may be shaped by rounding, bevelling, or chamfering. Conveniently, a rounded corner may be produced using a lathe. By contrast, a straight bevel may require alternative manufacturing techniques. For example, it may be necessary to employ a five axis CNC mill. It may be that the corners of one or both of the body portions 120, 160 are rounded or otherwise shaped as described above in various embodiments.

Where the corners 150 of the top body portion 120 and the bottom body portion 160 are so shaped, a gap may be provided between the respective corners when aligned. For example, as shown in FIG. 1, the corners of the top body portion 120 and the body portion may be sized to have a gap of height h therebetween when measured at the edges of the body portions proximate the corners. It may be that the gap height h is between 1 and 2 centimetres. For example, the gap height h may be about 1.5 cm. Where a corner of only one or the other of the top body portion 120 and the bottom body portion 160 are so shaped, the gap may of approximately half the height—e.g. between 0.5 and 1 centimetres or about 0.75 cm.

Further, when the corners 150 of one or both the top body portion 120 and the bottom body portion 160 are so shaped, the aforementioned gap may span between the outer edge of one of the body portions 120, 160 and the corresponding ones of the grinding assemblies 220, 260. As shown in FIGS. 4A and 4B, for example, the gap may span a length d. It may be that the length d is between 0.75 and 1.5 centimetres. For example, the length d may be about 1 cm.

The bottom grinding assembly 260 is substantially cylindrical. The bottom grinding assembly 260 may have a diameter larger than the outside diameter of the portion of the top grinding assembly 220 extending from the top body portion 120 to allow the top grinding assembly 220 to be received in the bottom grinding assembly 260 to assemble the grinder 100. Conveniently, in this way, the above-discussed grinding chamber may be defined. In particular, when the grinder 100 is assembled, the grinding chamber may be defined by the faces of each of the grinding assemblies 220, 260 and the inner edge 250 of the top grinding assembly 220.

As illustrated, the grinding assembly may, analogous to the top grinding assembly 220, include a plurality of teeth 270. Teeth 270 of the bottom grinding assembly 260 may be arranged in manners similar to the teeth 230 of the top grinding assembly 220. Notably, however, the teeth 230, 270 are arranged so as to permit assembly of the grinder 100 and, more particular, to allow relative rotation between the grinding assemblies 220, 260 without interference between teeth 230 and teeth 270 as would unnecessarily hinder such rotation. As further described below, the teeth 270 of the bottom grinding assembly 260 may be positioned relative to the teeth 230 of the top grinding assembly 220 (and, therefore, vice-versa), so as to permit the pluralities of teeth 230, 270 to cooperate to provide or enhance grinding.

Additionally, as briefly suggested above, the teeth 270 of the bottom grinding assembly 260 may have various edges akin to the teeth 230 of the top grinding assembly 220. For example, a given tooth 270 may, as illustrated, have a straight cutting edge 272, a cutting edge having a filleted base 274 and/or a cutting edge 276 that is substantially perpendicular to the axis of the relative rotation A. The straight cutting edge 272 and the cutting edge having a filleted base 274 are akin to the straight cutting edge 232 (FIG. 2A) and the cutting edge having filleted base 234 (FIG. 2A), respectively, and may co-operate therewith in manners described above. Additionally or alternatively, the cutting edge 276 is akin to the cutting edge 236 (FIG. 2A) and may provide similar benefits. Additionally or alternatively, one or more vanes 278 may be provided extending along one or both of the faces of the tooth 270 that are approximately tangential to the relative rotation/the circle to which that particular tooth 270 belongs, akin to the one or more vanes 238 (FIG. 2A).

An inner edge 280 of the bottom grinding assembly 260 may, as shown, be relatively smooth or untextured. Conveniently, a smooth inner edge may enhance the ease of rotating one of the body portions relative to the other of the body portions.

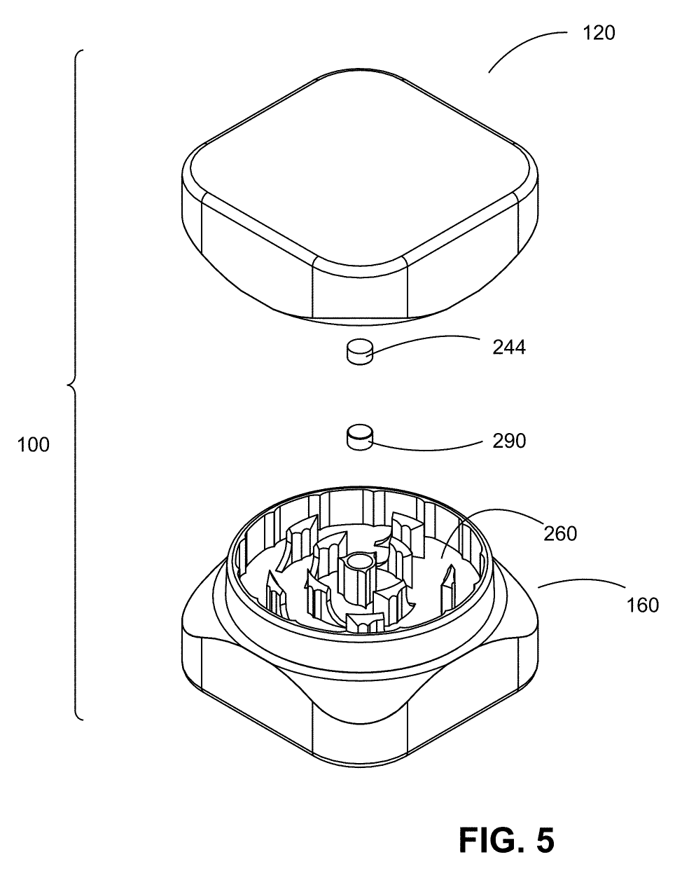

The base of the bottom grinding assembly 260 may, as shown, include a recessed or inset magnet 290. The magnet 290 of the bottom grinding assembly 260 may co-operate with the magnet 244 of the top grinding assembly 220 in manners described above such as to provide selective closure of the grinder 100. Relative positioning of the magnets 244, 290 is shown in FIG. 5. Notably, in addition to suitable positioning, each of the magnets 244, 290 must have poles positioned appropriately to facilitate such cooperation. Further, each of the magnets 244, 290 may positioned so that the interaction of their magnetic fields does not impede relative rotation and/or so that relative rotation does not require disengaging the magnets 244, 290. Alternatively, one the magnets 244, 290 may be substituted with a suitable ferromagnetic or magnetic material as can cooperate with the other of the magnets 244, 290. The ferromagnetic material may, for example, be the material of one or both of the grinding assemblies 220, 260.

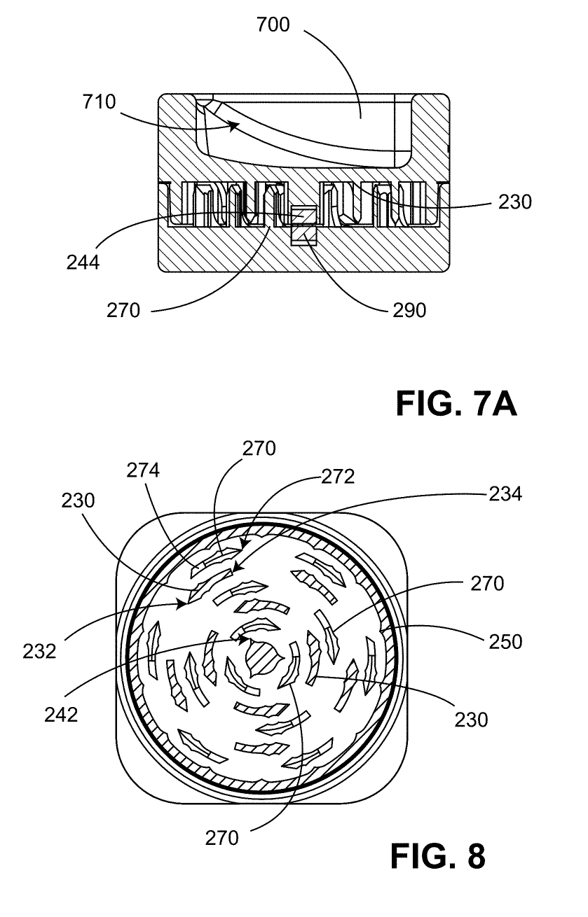

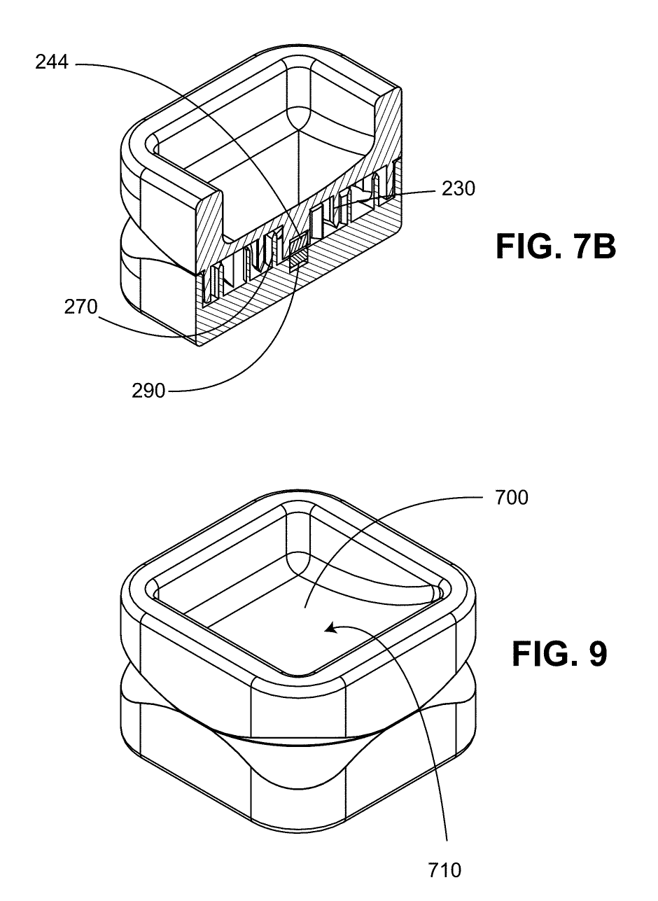

As discussed above, the teeth 230 of the top grinding assembly 220 and the teeth 270 of the bottom grinding assembly 260 may cooperate during operation of the grinder 100. In particular, it may be that the relative arrangement of the teeth 230, 270 acts to provide or enhance grinding. The relative arrangement of the teeth 230, 270 is illustrated by way of FIGS. 7A. FIG. 7A is an elevation view of a section of the grinder of FIG. 7, along the line 7-7 in the direction of the arrows;

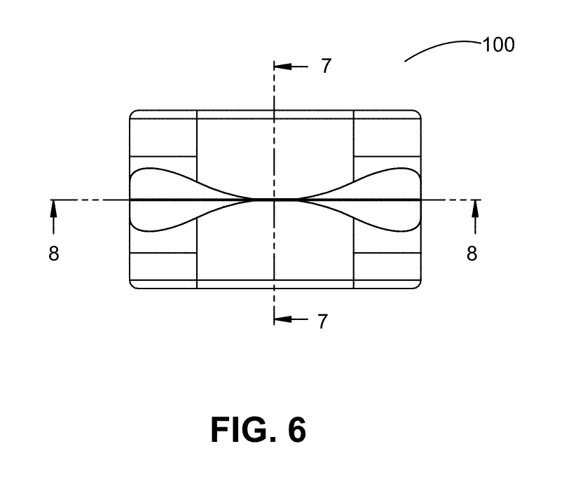

FIGS. 7A and 7B show elevation and perspective views, respectively, of a section of the grinder 100 along a line 7-7 as shown in FIG. 6. FIG. 8 is an elevation view of the grinder of FIG. 6 along the line 8-8 in the direction of the arrows.

FIGS. 7A, 7B and 8, show the spacing of the teeth 230, 270.

As discussed above, one or both of the teeth 230 of the top grinding assembly 220 and the teeth 270 of the bottom grinding assembly 260 may be arranged in concentric circles. Further as discussed above, the teeth 230, 270 are placed so that the will not substantially interfere with relative rotation of the body portions 120, 160. As shown best in FIG. 8, this may be achieved by arranging the teeth 230 and the teeth 270 so that they form concentric circles with each other. For example, the applicant has found experimentally that teeth spaced and sized to form a 3-4-4-5-6 arrangement of teeth in concentric (going from inside to outside) may be provide favourable grind characteristics, particularly for grinding cannabis.

Referring again to FIGS. 7A, 7B and 8, the teeth 230, 270 are spaced in manners that they may cooperate. In particular, the teeth 230, 270 are spaced so that suitably sized pieces of material may be pulled between a tooth 230 and a tooth 270 that are arranged along circles that become proximate when the body portions 120, 160 are assembled. Notably, vanes 238 (FIG. 2A) and 278 (FIG. 2B) of such a tooth 230 (FIG. 2A) and such a tooth 270 (FIG. 2B), respectively, may cooperate to provide opposed shear forces to material so pulled therebetween. Put differently, vanes of a first tooth one of the teeth 230 of the top grinding assembly 220 and the teeth 270 of the bottom grinding assembly 260, the tooth including one or more vanes extending on a face thereof may cooperate with vanes extending on a face of a second tooth of the other of the teeth 230 of the top grinding assembly 220 and the teeth 270 of the bottom grinding assembly 260 during relative rotation when respective ones of the faces of the first and second tooth having vanes are at least partially opposed so as to apply shear forces to material in the grinding chamber. Conveniently, application of opposed shear forces may act to enhance grinding.

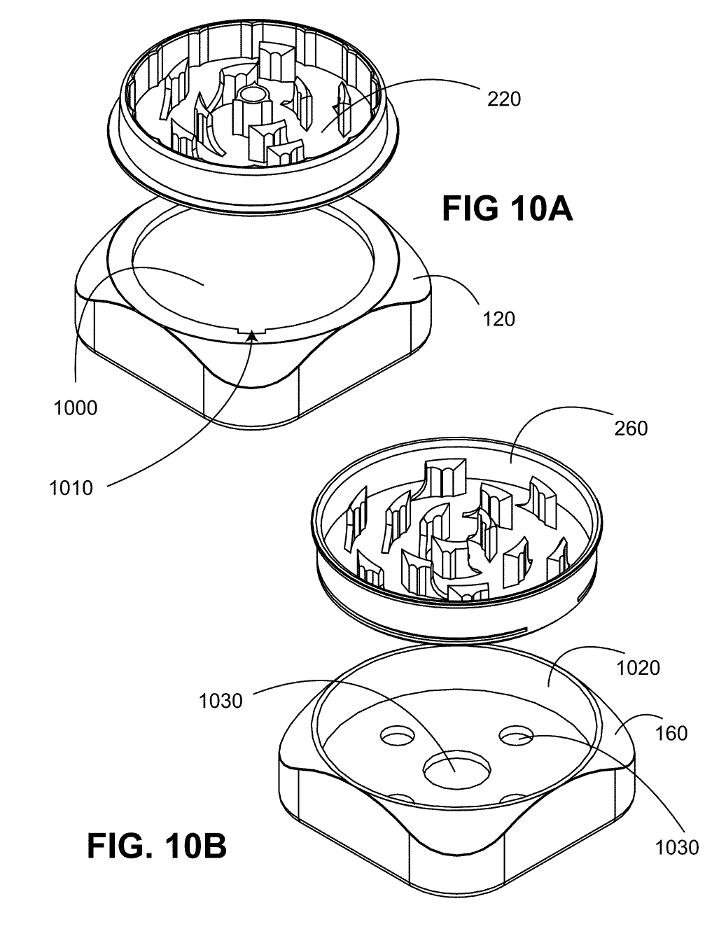

As shown in FIG. 7A, an outside face of the top body portion 120 may be inset to provide a tray 700. Put differently, a recessed portion of such an outer face of the top body portion 120 may provide the tray 700. Tray 700 is also shown in a plan view in FIG. 10. The tray 700 may be adapted for use as an ashtray such as, for example, if the grinder 100 is used for grinding cannabis for forming a joint. Additionally or alternatively, the tray 700 may be used as a dish for collecting ground material. After grinding, material will come to rest in the bottom body portion 160 if the grinder 100 is suitably oriented so that gravity can operate on the ground material. Conveniently, where an instance of the tray 700 is provided in the top body portion 120, the top body portion 120 may be separated from the bottom body portion 160 and ground material may then be tipped into the tray 700. The tray 700 may include a ledge 710 such as may be formed by appropriate sloping or contouring of the base of the tray 700.

Conveniently, the ledge 710 may act as a rest for supporting, for example, a burning cigarette if the tray 700 is used as an ashtray. Additionally or alternatively, a suitably contoured ledge 710 may act as a funnel or guide allowing material in the tray 700 to be poured.

In addition or as an alternative to providing the tray 700 in the top body portion 120, the bottom body portion 160 may be inset to provide such a tray. Notably, however, providing the tray 700 in the top body portion 120 may be more convenient due to the need to accommodate the insetting of the top grinding assembly 220 in the bottom body portion 160.

Grinders in accordance with the foregoing may be manufactured in various methods. In one example, halves of the grinder 100—i.e. the top and body portions 120, 160 and their respective grinding assemblies 220, 260 may be monolithically formed. For example, the top and body portions 120, 160 may be each formed of aluminium. The aluminum may be formed into an appropriate shape such as, for example, by way of a CNC mill. Finishing steps may then be performed such as, for example, to install the magnets 244, 290.

It may in some cases, however, be undesirable to form each half of the grinder out of the same material. For example, it may be preferable for reasons of function and/or aesthetics to form the grinding assemblies 220, 260 out of different materials than the body portions 120, 160.

For example, a potentially more aesthetically pleasing body portion may be formed of materials such as, for example, stone, gemstones or wood. In another example, a potentially lighter or lower-cost body portion may be formed of wood or plastic. In another example, a potentially more durable blade may be formed of stainless steel instead of aluminum. Various combinations of materials may offer one or more of the aforementioned benefits. Additionally, particular combinations may offer benefits by virtue of the combination. For example, a grinder suitable for medical use and/or autoclaving might be formed with surgical stainless-steel blades and a suitable plastic body.

FIGS. 10A and 10B are exploded perspective views of grinders showing top and bottom portions thereof, respectively, according to further alternate embodiments.

FIG. 10A shows an embodiment in which the top body portion 120 and the top grinding assembly 220 have been separately formed for subsequent assembly.

The top grinding assembly 220 may be assembled with its respective body portion—i.e., the top body portion 120, in various manners.

As illustrated, top body portion 120 may be formed with a cavity 1000 for receiving a base of the top grinding assembly 220. It may be that the cavity is formed with sufficient tolerances so that the top grinding assembly 220 and, in particular, the base thereof, also formed with sufficient tolerances, is retained therein by way of a friction fit. Additionally or alternatively, the grinding assembly may be retained in the cavity by way of a locking fit. In particular, it may be that two or more tabs or arms (not shown) along the base of the top grinding assembly 220 are formed to fit in slots 1010 formed along the edge of the cavity 1000. The top grinding assembly 220 may be then rotated using a suitable tool so that the tab can come to rest in a groove (not shown) formed proximate each of the slots 1010.

It may be that where tabs and slots are provided, the positions of the tabs, slots, and grooves may be swapped from the what was described above, such that the tabs are provided on the bottom body portion 160 and slots are provided on the top grinding assembly 220.

Additionally or alternatively, if the portion of top body portion 120 cooperating with the base of the top grinding assembly 220, such as, for example, a sidewall of the cavity 1000, is formed of an appropriate material such as, for example, a flexible plastic, and the top grinding assembly 220 is formed of a suitably rigid material such as, for example, a suitable metal, then the top grinding assembly 220 may be retained in the base by way of an interference fit.

Additionally or alternatively, a suitable adhesive such as, for example, epoxy may be used to secure the base of the top grinding assembly 220 in the cavity 1000 of the body portion. A consideration in selecting an adhesive may be compatibility with the materials used to form at least the portions of the top grinding assembly 220 and the top body portion 120—e.g., the cavity 1000—participating in the bonding.

The subject matter illustrated in FIG. 10A and described above may also be applied to the bottom body portion 160 and the bottom grinding assembly 260.

FIG. 10A shows another embodiment in which the bottom body portion 160 may and the bottom grinding assembly 260 have been separately formed for subsequent assembly.

As illustrated, the bottom body portion 160 may be formed with a cavity 1020 for receiving the bottom grinding assembly 260 so that the bottom grinding assembly 260 may become inset therein.

The bottom body portion 160 may be retained in the cavity 1020 in manners similar to those described above for retaining the base of the top grinding assembly 220 in the cavity 1000 in the embodiment illustrated in FIG. 10A including, for example, by way of a friction fit, an interference fit, an adhesive, or some combination thereof.

As illustrated, the bottom body portion 160 may be formed with one or more insets 1030 in the base of the cavity 1020. The one or more insets 1030 may be used for retaining the bottom grinding assembly 260 in the bottom body portion 160.

In one example, the bottom grinding assembly 260 may have one or more outsets (not shown) corresponding to the one of more insets 1030. The bottom grinding assembly 260 may be driven into the cavity 1020 to engage the outsets with the insets and provide a friction fit. Additionally or alternatively, the one or more outsets may have a cross-section slightly greater than corresponding ones of the one or more insets 1030. Conveniently, in this way, a displacement or interference fit may be achieved between the bottom grinding assembly 260 and the bottom body portion 160 if they are each formed of suitable materials. For example, a displacement fit may be achieved between an aluminum or stainless steel bottom grinding assembly 260 and a wood bottom body portion 160.

Where adhesive is used to secure the bottom grinding assembly 260 in the cavity 1020, adhesive may be applied to the one or more insets 1030. In particular, adhesive may be applied in the insets 1030 either exclusively or in addition to adhesive as may be otherwise applied to all or portions of the cavity 1020/the bottom body portion 160. Conveniently, the insets 1030 may allow additional adhesive to be utilized as compared to if the insets 1030 were omitted. The insets 1030 may also allow for a greater surface area of a bond. Being able to use additional adhesive and/or a greater bond surface area may allow a stronger bond to be provided. Alternatively, using additional adhesive and/or a greater bond surface area may allow a sufficient bond to that provided while using an adhesive with weaker bonding properties than may otherwise be utilized. Alternatively, it may be that absent the insets 1030 a sufficient bond cannot be achieved such as, for example, where one or both of bottom body portion 160 or the bottom grinding assembly 260 is formed of material(s) that are difficult to bond. It may be that an adhesive bond between the bottom grinding assembly 260 and the bottom body portion 160 is combined with a friction or displacement fit between those same components for greater durability and/or to reduce cost such as, for example, by allowing the use of reduced quantities of adhesive.

It may be that where corresponding insets and outsides are provided, the positions of the outsets and insets may be swapped from the what was described above, such that the outsets are provided on the bottom body portion 160 and insets are provided on the bottom grinding assembly 260. Alternatively, corresponding insets and outsets may be provided with the insets and outsets being located variously on each of the bottom body portion 160 and the bottom grinding assembly 260.

The subject matter illustrated in FIG. 10B and described above may also be applied to the top body portion 120 and the top grinding assembly 220. Further features described with respect to one of those drawings may be combined with suitable ones of the features described with respect to the other of those drawings such as, for example, by combined a locking fit mechanism with adhesive cavities.

As mentioned above, the grinding assemblies 220, 260 may be formed of various materials and in various manners. For example, one or both of the grinding assemblies may be formed of a metal such as, for example, aluminum or steel. For example, a stainless-steel blade may be formed of 420 stainless steel. Conveniently, because 420 stainless steel is a particularly hard stainless steel, a grinding assembly formed of 420 stainless steel may be advantageous in maintaining a cutting edge.

A metal grinding assembly may be machined from a suitable block or piece of material such as, for example, by way of a CNC mill.

Additionally, various processes may be performed following milling. For example, a grinding assembly formed of a suitable material such as, for example, aluminum may be sand blasted to remove tooling marks. Additionally or alternatively, a machined grinding assembly may be subjected to one or more treatments such as, for example, chemical treatments. In one example, a non-ferrous grinding assembly such as, for example, a grinding assembly formed of aluminum may be anodized to improve wear properties. Additionally, colour may be applied to a grinding assembly for aesthetic reasons such as, for example, by dyeing an anodized grinding assembly.

Additionally or alternatively, it may be that processes are applied to metals before or after milling. For example, it may be that metals are forged.

Body portions 120, 160 may also be formed in various manners.

In one example, a body portion may be formed from wood using woodworking techniques such as, for example, by sawing, drilling, routing, using a lathe, and the like. Wood used in forming such a body portion may be treated such as, for example, by a food grade wax finish. A food grade wax finish may be applied, for example, by applying suitable food grade oil(s) and wax(es) to the body portions. Conveniently, a food grade wax finish may protect the body portion while protecting against contamination of material to be ground. Additionally, a wooden body portion may be subjected to one or more treatments such as for example, staining, sealing such as, for example with a varnish or a polyurethane, oiling, or painting. Such treatments may variously have aesthetic and/or functional benefits. For example, sealing the surface of a wooden body portion may improve resistance to cracking and/or moisture.

In another example, a body portion may be formed of a stone or a gemstone. A body portion formed of stone or gemstone may be machined using milling techniques such as, for example, using a CNC mill. In particular, when milling stone or gemstone, a water-cooled CNC mill may be employed.

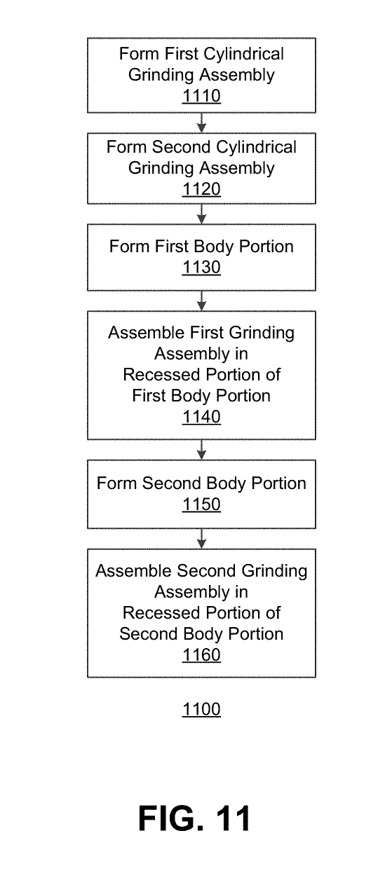

FIG. 11 shows a flow chart 1100 illustrating operations in an example method for manufacturing a grinder out of multiple materials.

First, at an operation 1110, a first cylindrical grinding assembly is formed. The first cylindrical grinding assembly may correspond to the top grinding assembly 220 as described above. The first cylindrical grinding assembly may be formed in manners such as, for example, as described above. In a particular example, the first grinding assembly may be formed using a CNC mill. The first cylindrical grinding assembly includes a first plurality of teeth. For example, where the first cylindrical grinding assembly corresponds to the top grinding assembly 220, the first plurality of teeth may correspond to the teeth 230.

Next, at an operation 1120, a second cylindrical grinding assembly is formed. The second cylindrical grinding assembly may correspond to the bottom grinding assembly 260 as described above. The second cylindrical grinding assembly is adapted to be received in the first grinding assembly to define a grinding chamber. The second cylindrical grinding assembly includes a second plurality of teeth. For example, where the second cylindrical grinding assembly corresponds to the bottom grinding assembly 260, the second plurality of teeth may correspond to the teeth 270. The second plurality of teeth are positioned to allow relative rotation between the first and second grinding assemblies without interference between teeth of the first and second plurality of teeth. For example, the second plurality of teeth may be positioned consistent with manners of positioning of the teeth 230, 270 as described above. The second cylindrical grinding assembly may be formed in various manners, such as for example, in manners as described above. In a particular example, the second grinding assembly may be formed in the same manner as the first grinding assembly.

Next, at an operation 1130 a first substantially square-cuboid-shaped body portion is formed. The first substantially square-cuboid shaped body portion has a recessed portion in a substantially square face thereof. The recessed portion is adapted for receiving the first grinding assembly. The first body portion may correspond to the top body portion 120. The first body portion may be formed using various techniques such as, for example, techniques as described above. For example, the first body portion may be formed using techniques suitable for a particular selected material or materials. In a particular example, if the first body portion is formed of wood, woodworking tools and techniques may be used to form the first body portion. For example, a lathe and/or a CNC mill may be employed. In another example, the first body portion may be formed of a gemstone or a gemstone such as, for example, by way of a water-cooled CNC mill. The first body portion may be formed appropriately to allow joining to a suitably formed first grinding assembly. For example, the first body portion may be formed with slots for receiving corresponding tabs of the first grinding assembly. Similarly, provision may be made for a friction fit, a displacement fit, an interference fit and/or using an adhesive, etc. in manners described above as may be suitable for materials selected for the first grinding assembly and/or the first body portion.

Next, at an operation 1140, the first grinding assembly is assembled in the recessed portion of the first body portion. The first grinding assembly is secured in the recessed portion of the first body portion. The first grinding assembly may be secured in the recessed portion such as, for example, in manners described above.

Next, at an operation 1150, a second substantially square-cuboid-shaped body portion is formed. The second substantially square-cuboid shaped body portion has a recessed portion in a substantially square face thereof. The recessed portion is adapted for partially receiving the second grinding assembly—i.e., so that the second grinding assembly extends from the substantially square face of the second body portion. The second body portion may correspond to the bottom body portion 160 and may be formed in various such as, for example, in manners described above. For example, the second body portion may be formed in the same or similar manner to the first body portion.

Next, at an operation 1160, the second grinding assembly is assembled in a recessed portion of the second body portion so that the second grinding assembly extends from the substantially square face of the second body portion. The second grinding assembly is secured in the recessed portion of the second body portion in the partially ending position. The second grinding assembly may be secured in the recessed portion in various manners such as, for example, in manners described above in the discussion of the assembly of the first grinding assembly in the first body portion at the operation 1140.

Notably, at least one of the first body portion and the second body portion is formed (at the operation 1130 and/or the operation 1160, respectively) so that corners of at least one of the first and second body portions proximate the respective substantially square face thereof and proximate a respective one of the first and second grinding assemblies are shaped to avoid striking digits of a user gripping the other of the first and second body portions during the relative rotation. In some embodiments, both of the first and second body portions may be so formed.

Grinders consistent with the description of the grinder 100 may be formed consistent with the method illustrated in the flow chart 1100.

Of course, the various operations of FIG. 11 may be performed in various other orders without changing the nature of the manufacturing methods. For example, the various components may all be formed before performing any assembly.

In another example of forming a grinder out of multiple materials, it may be that a body portion is formed of a suitable plastic such as, for example, polycarbonate. A plastic body portion may be formed using various moulding techniques such as, for example, using injection molding techniques. In a particular example, it may be that a body portion is over moulded on a previously formed grinding assembly such as, for example, by way of injection molding. Conveniently, over molding a body portion may allow the body portion to stay attached to the grinding assembly without the use of other attachment techniques. For example, use of adhesive may be avoided or eliminated. Conveniently, a grinder formed of suitable grinding assemblies with over molded body portions may be especially durable and/or adapted for harsh environments. For example, a stainless-steel grinding assembly such as, for example, a grinding assembly formed of 420 stainless steel, may be over molded with a body portion formed of Polyether ether ketone (PEEK) in manufacturing a grinder adapted for sterilization/sanitization using an autoclave. A grinder suitable for autoclave sterilization may be desirable in various application such as, for example, when the grinder is employed for preparing medical cannabis in a hospital or hospice setting.

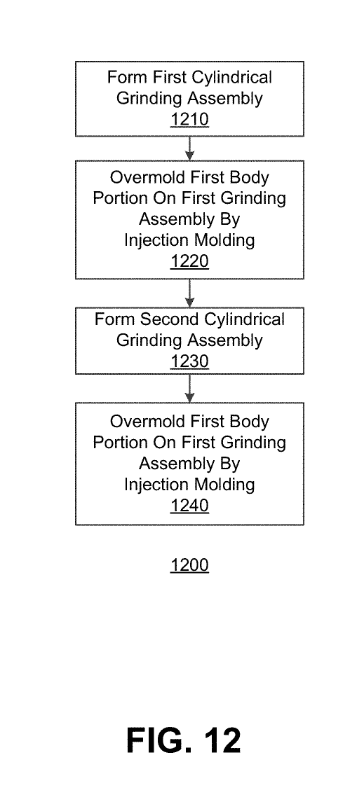

FIG. 12 shows a flow chart 1200 illustrating operations in an example method for manufacturing a grinder out of multiple materials using injection molding and, in particular, over molding.

First, at an operation 1210, a first cylindrical grinding assembly is formed. The first cylindrical grinding assembly may correspond to the top grinding assembly 220 as described above. The first cylindrical grinding assembly may be formed in manners such as, for example, as described above. In a particular example, the first grinding assembly may be formed using a CNC mill. The first cylindrical grinding assembly includes a first plurality of teeth. For example, where the first cylindrical grinding assembly corresponds to the top grinding assembly 220, the first plurality of teeth may correspond to the teeth 230.

Next, at an operation 1220, using injection molding, a first substantially square-cuboid-shaped body portion is formed by over moulding the first body portion over the first grinding assembly so that the first grinding assembly is recessed therein in a substantially square face of the first body portion. The first body portion may be formed of Polyether ether ketone (PEEK) plastic. Additionally or alternatively, the first body portion may be formed of polypropylene and/or Acrylonitrile butadiene styrene (ABS).

Next, at an operation 1230, a second cylindrical grinding assembly is formed. The second cylindrical grinding assembly may correspond to the bottom grinding assembly 260 as described above. The second cylindrical grinding assembly is adapted to be received in the first grinding assembly to define a grinding chamber. The second cylindrical grinding assembly includes a second plurality of teeth. For example, where the second cylindrical grinding assembly corresponds to the bottom grinding assembly 260, the second plurality of teeth may correspond to the teeth 270. The second plurality of teeth are positioned to allow relative rotation between the first and second grinding assemblies without interference between teeth of the first and second plurality of teeth. For example, the second plurality of teeth may be positioned consistent with manners of positioning of the teeth 230, 270 as described above. The second cylindrical grinding assembly may be formed in various manners, such as for example, in manners as described above. In a particular example, the second grinding assembly may be formed in the same manner as the first grinding assembly.

Next, at an operation 1240, using injection molding, a second substantially square-cuboid-shaped body portion is formed by over moulding the second body portion over the second grinding assembly so that the second grinding assembly is partially recessed therein in a substantially square face of the second body portion. The second body portion may be formed of Polyether ether ketone (PEEK) plastic. Additionally or alternatively, the second body portion may be formed of polypropylene and/or Acrylonitrile butadiene styrene (ABS).

Notably, the injection molding of at least one of the first body portion and the second body portion is adapted to form—e.g., to mold (at the operation 1220 and/or the 1240, respectively)—corners of at least one of the first and second body portions proximate the respective substantially square face thereof and proximate a respective one of the first and second grinding assemblies configured to avoid striking digits of a user gripping the other of the first and second body portions during the relative rotation. In some embodiments, both of the first and second body portions may be so formed.

Grinders consistent with the description of the grinder 100 may be formed consistent with the method illustrated in the flow chart 1200.

Of course, the various operations of FIG. 12 may be performed in various other orders without changing the nature of the manufacturing methods. For example, the various grinding assemblies may both be formed before performing any over molding.

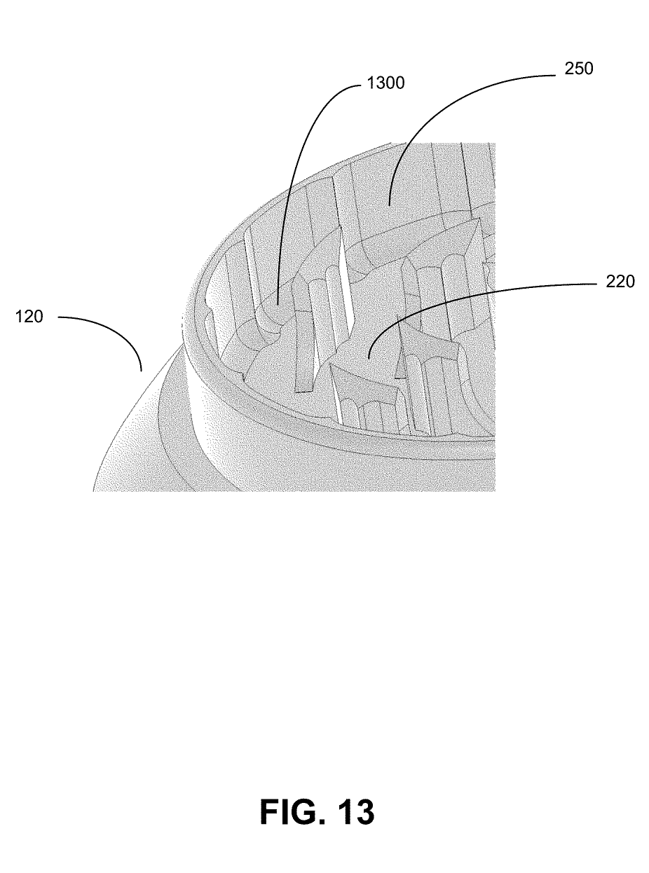

It may be that in some applications of a grinder consistent with the present disclosure, material may collect along one or both of the inner edge 250 of the top grinding assembly 220 and the inner edge 280 of the lower grinding assembly 260. Referring to FIG. 13, in some embodiments there may be provided a radius contour 1300 going from the inner edge 250 to the floor of the top grinding assembly 220. Conveniently, such a radius contour may act to prevent or limit accumulation of ground material at the interface between the inner edge 250 and the floor of top grinding assembly 220.

In some embodiments, it may be that scallops of the inner edge 250 continue onto the radius contour 1300. Conveniently such scallops may act in manners similar to the scallops of the inner edge 250 such as, for example, to further prevent or limit material collecting around the inner edge 250 and/or along the radius contour 1300.

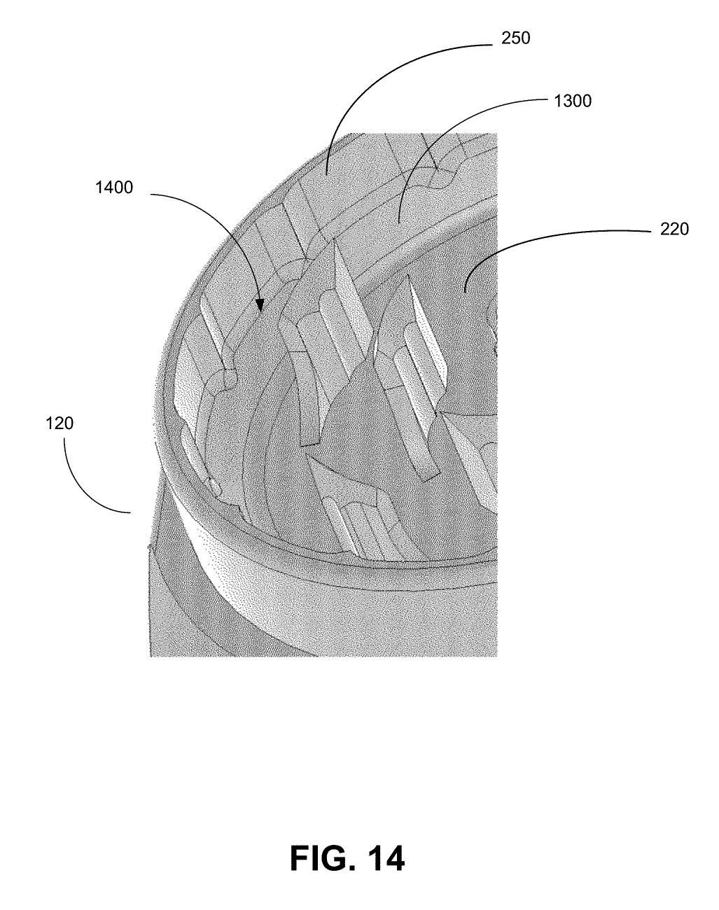

Alternatively, as shown in FIG. 14, it may be that the scallops terminate above an top edge 1400 of the radius contour 1300. It may be that terminating the scallops above the top edge 1400 makes the top grinding assembly 220 easier to form as compared to one where the scallops continue onto the radius contour 1300.

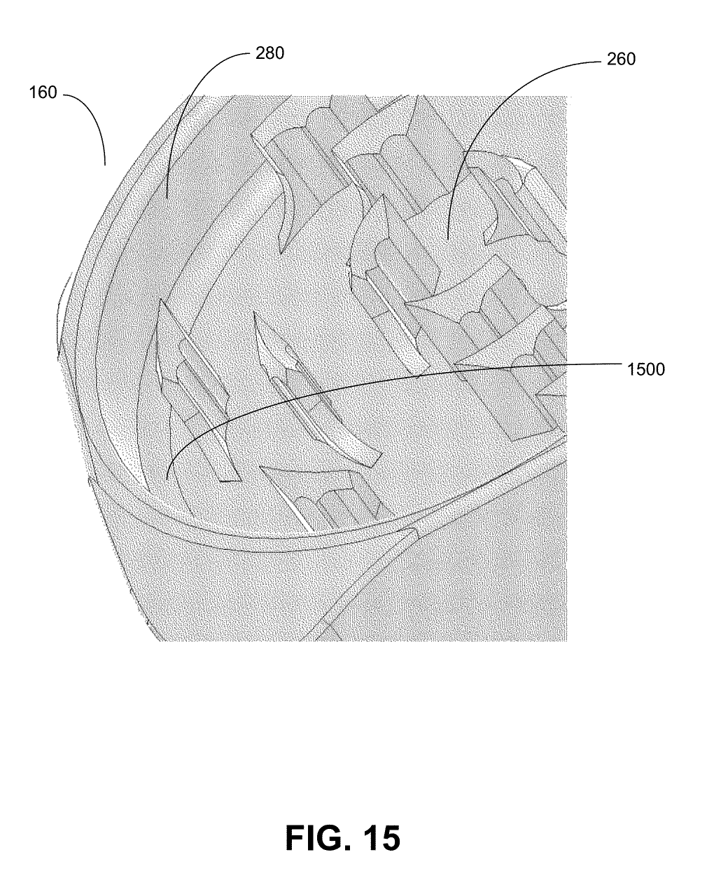

Referring to FIG. 15, similar to the possible accumulation of material discussed above as regards the inner edge 250 and the top grinding assembly 220, it may additionally or alternatively be that material may accumulate between the inner edge 280 of the lower grinding assembly 260. As such, it may be that a radius contour 1500 is provided going from the inner edge 280 to the floor of the bottom grinding assembly 260. Conveniently, the radius contour 1500 may act to prevent or limit accumulation of ground material at the interface between the inner edge 250 and the floor of top grinding assembly 220 in manners similar to the radius contour 1300 discussed above.

It should be noted that the above-mentioned embodiments illustrate rather than limit the subject matter of the present invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The mere fact that certain measures are recited in mutually different dependent claims does not indicate that a combination of these measures cannot be used to advantage.

What is claimed is:

1. A grinder comprising:
a first substantially square-cuboid-shaped body portion having a first cylindrical grinding assembly recessed in a substantially square face thereof, the first cylindrical grinding assembly including a first plurality of teeth;
a second substantially square-cuboid-shaped body portion;
a second cylindrical grinding assembly extending from a substantially square face of the second substantially square-cuboid-shaped body portion and adapted to be rotateably received in the first grinding assembly to define a grinding chamber, the second grinding assembly including a second plurality of teeth positioned to allow relative rotation between the first and second grinding assemblies without interference between teeth of the first and second plurality of teeth,
wherein corners of one of the first and second body portions proximate a respective one of the first and second grinding assemblies are shaped to avoid striking digits of a user gripping the other of the first and second body portions during the relative rotation.

2. The grinder of claim 1 wherein the corners of the other of the first and second body portions are shaped to avoid striking digits of a user gripping the one of the first and second body portions during the relative rotation.

3. The grinder of claim 1 wherein the corners are shaped by rounding, bevelling, or chamfering.

4. The grinder of claim 1 wherein at least three teeth of the first and second plurality of teeth are arranged to define one or more circles coaxial with an axis of the relative rotation, the at least three teeth being arranged circumferentially along the one or more circles.

5. The grinder of claim 1 wherein at least one tooth of the first and second pluralities of teeth has a first substantially straight cutting edge and a second cutting edge having a filleted base, the first and second cutting edges being positioned so that material received in the grinding chamber is attacked by the first cutting edge when the relative rotation is in a first direction and by the second cutting edge when the relative rotation is in a direction opposite to the first direction.

6. The grinder of claim 1 wherein at least one tooth of the first and second pluralities of teeth includes one or more vanes extending along one or more faces of the at least one tooth, the one or more faces being at least partially tangential to the relative rotation, wherein the vanes apply a shear force during the relative rotation to material received in the grinding chamber.

7. The grinder of claim 6 wherein a first tooth of one of the at least one tooth including one or more vanes extending on a face thereof cooperates with vanes extending on a face of a second tooth of the second plurality of teeth during the relative rotation when respective ones of the faces of the first and second tooth having vanes are at least partially opposed to apply opposed shear forces to material in the grinding chamber.

8. The grinder of claim 7 wherein the vanes of the first and second teeth extend substantially parallel to an axis of the relative rotation.

9. The grinder of claim 1 wherein one or more teeth of the first and second pluralities of teeth are arc-shaped.

10. The grinder of claim 1 wherein one or more teeth of the first and second pluralities of teeth have one or more cutting edges substantially parallel to an axis of the relative rotation.

11. The grinder of claim 1 wherein one or more teeth of the first and second pluralities of teeth have a cutting edge substantially perpendicular to an axis of the relative rotation.

12. The grinder of claim 11 wherein at least one of the first and second grinding assemblies includes an axle.

13. The grinder of claim 12 wherein the axle includes a magnet for selectively magnetically retaining the one of the first and second grinding assemblies to the other of the first and second grinding assemblies.

14. The grinder of claim 13 wherein the magnet cooperates with a second magnet of the other of the first and second grinding assemblies for the magnetically retaining.

15. The grinder of claim 12 wherein one or more vanes extend along the axle.

16. The grinder of claim 15 wherein the one or more vanes extend along the axle in a direction substantially parallel to an axis of the relative rotation.

17. The grinder of claim 1 wherein an inner edge of the second grinding assembly is scalloped.

18. The grinder of claim 1 wherein an outside face of at least one of the first and second body portions includes a recessed portion defining a tray.

19. The grinder of claim 1 wherein the first and second body portions each have a rounded square or a squircle cross-section.

20. The grinder of claim 1 wherein a radius contour is provided between an inner edge of at least one of the first and second grinding assemblies and a base of that assembly.
